(19) United States
(12) Patent Application Publication
(10) Pub. No.: US 2007/0088591 A1
(43) Pub. Date: Apr. 19, 2007

(54) ALARM SYSTEM AND METHOD FOR PRODUCTION SCHEDULE CONTRONL

(75) Inventors: Yun-Feng Xie, Shenzhen (CN); Ci-Qiong Zhu, Shenzhen (CN); Zhi-Yong Xu, Shenzhen (CN); Chun-Yan Zhu, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., TU CHENG (TW)

(21) Appl. No.: 11/308,688

(22) Filed: Apr. 21, 2006

(30) Foreign Application Priority Data
Oct. 14, 2005 (CN) 200510100376.0

(51) Int. Cl. G06F 9/46

(52) U.S. Cl. 705/8

(57) ABSTRACT

An alarm system (10) includes a plan management module (100), a production management module (200) and an alarm management module (300). The plan management module receives a customer order and sets planned delivery data according to the customer order. The production management module downloads production data. The alarm management module determines whether the production data conform to the planned delivery data and generates an alarm if the production data do not conform to the planned delivery data. A related method for production schedule control is also provided.

### DESCRIPTION

1. Field of the Invention

The invention relates to alarm systems, and particularly to an alarm system and method for production schedule control.

2. Description of Related Art

Due to varying product demands by customers, production schedules vary from order to order. This results in an inability for manufacturers to have uniform long range planning for their production processes. This built-to-order method of manufacturing may lead to problems in a factory's ability to fulfill their commitments. For example, actual production may lag behind planned production, but not be noticed until too late to take action and put production back on track again. Accordingly, what is needed is a way to alert workers when there is a potential problem to meeting their planned schedule of production in a timely fashion.

### SUMMARY OF INVENTION

An exemplary embodiment of the present invention provides an alarm system for production schedule control. The alarm system includes a plan management module, a production management module, and an alarm management module. The plan management module receives a customer order and sets planned delivery data according to the customer order. The production management module downloads production data. The alarm management module determines whether the production data conform to the planned delivery data, and generates an alarm if the production data do not conform to the planned delivery data.

Another exemplary embodiment of the present invention provides a method for production schedule control. The method includes the steps of: receiving a customer order; setting planned delivery data according to the customer order; downloading production data; determining whether the production data conform to the planned delivery data; and generating an alarm if the production data do not conform to the planned delivery data.

Employing the above system and method, when actual production does not conform to a planned production schedule, an alarm is generated so steps can be taken to ensure delivery of products to customers on time.

Other advantages and novel features will become more apparent from the following detailed description when taken in conjunction with the accompanying drawings, in which:

### BRIEF DESCRIPTION OF DRAWINGS

FIG. 1 is a schematic diagram of functional modules of an alarm system of an exemplary embodiment of the present invention;

FIG. 2 is a schematic diagram of functional modules of an alarm system of another exemplary embodiment of the present invention;

FIG. 3 is a flowchart of a method for production schedule control of an exemplary embodiment of the present invention; and

FIG. 4 is a flowchart of a method for production schedule control of another exemplary embodiment of the present invention.

### DETAILED DESCRIPTION

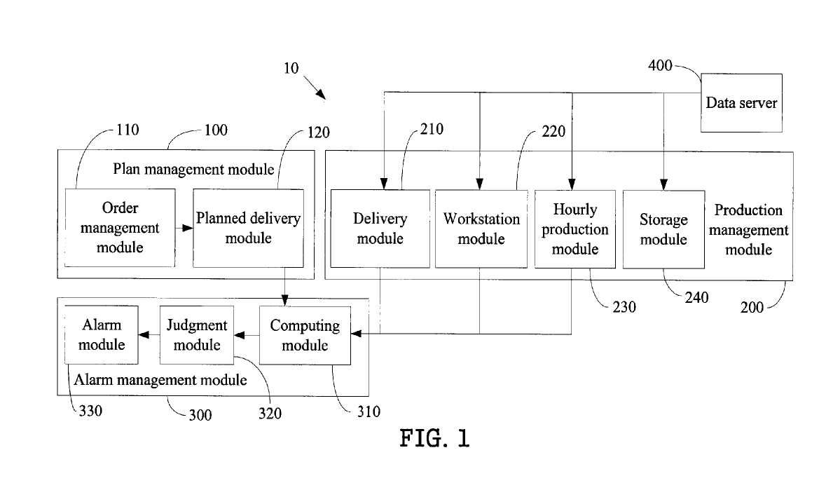

FIG. 1 is a schematic diagram of functional modules of an alarm system 10 of an exemplary embodiment of the present invention. In the exemplary embodiment, the alarm system 10 is used for production schedule control by generating an alarm when actual production does not conform to a planned production schedule. The alarm system 10 includes a plan management module 100, a production management module 200, and an alarm management module 300.

The plan management module 100 receives a customer order, sets planned delivery data according to the customer order, and then transmits the data to the alarm management module 300. The plan management module 100 further arranges a planned delivery schedule according to the customer order. In the exemplary embodiment, the plan management module 100 includes an order management module 110 and a planned delivery module 120.

The order management module 110 receives the customer order. In the exemplary embodiment, the customer order includes a plurality of finished products, and each finished product includes at least one semi-finished product. For example, the customer order may include a finished product such as a router, and the finished product is composed of a semi-finished product of a printed circuit board assembly (PCBA). The semi-finished product is manufactured by a plurality of workstations in a front-end order list. A rear-end workstation is used for packing the semi-finished product into the finished product.

In other embodiments, the customer order may include finished products of other kinds of electronic devices, and the finished products may include a plurality of semi-finished products. The finished products and the semi-finished products may be manufactured by more workstations.

The planned delivery module 120 sets the planned delivery data according to the customer order received by the order management module 110. The planned delivery data includes a planned delivery amount for each finished product.

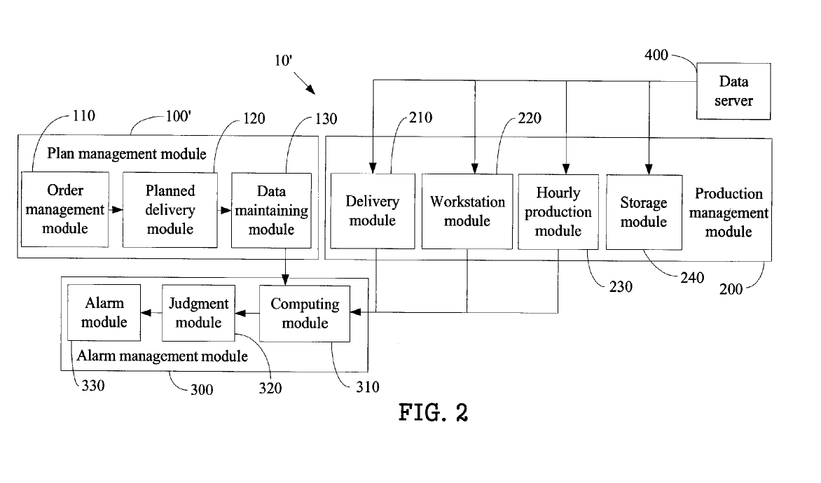

In another exemplary embodiment, referring to FIG. 2, functional modules of an alarm system 10′ are similar to the alarm system 10. The difference is that a plan management module 100′ further includes a data maintaining module 130. The data maintaining module 130 maintains the planned delivery data set by the planned delivery module 120, and includes searching, editing, deleting, and other functions.

In the exemplary embodiment, as shown in FIG. 1, the alarm system 10 further includes a data server 400. The data server 400 stores production data. The production data includes an hourly production amount of each finished product and each semi-finished product at each workstation thereof, a work-in-process (WIP) amount of each finished product and each semi-finished product at each workstation thereof, a delivered amount of each finished product, and a stored amount of each finished product.

For example, when the finished product is a router, its manufacturing procedure is as follows: processing of a printed circuit board (PCB) by each workstation in the front-end order list into a semi-finished product such as a PCBA; and processing the PCBA by the rear-end workstation into the finished product, namely the router. The front-end order list includes, from first to last, a loading workstation, a surface mounted technology (SMT) workstation, an automatic optical inspection (AOI) workstation, a visual inspection (VI) workstation, an in-circuit-test (ICT) workstation, and a printed circuit board two corners (PCB2C) workstation. The rear-end workstation includes a packing workstation for packaging the PCBA into the router. Each workstation has an hourly production amount. Each workstation further has a work-in-process (WIP) amount indicating the amount of boards waiting for processing by the workstation. For instance, the WIP amount of the PCB2C workstation is the amount of boards waiting for processing by PCB2C workstation, and the WIP amount of the ICT workstation is the amount of boards waiting for processing by the ICT workstation. The finished product further has a delivered amount indicating the amount of the finished product already delivered to customers, and a stored amount indicating the amount of the finished product stored in a storehouse.

The production management module 200 downloads the production data from the data server 400, and transmits the production data to the alarm management module 300.

In the exemplary embodiment, the production management module 200 includes a delivery module 210, a workstation module 220, an hourly production module 230, and a storage module 240. The delivery module 210 downloads the delivered amount of the finished product from the data server 400, and transmits the delivered amount to the alarm management module 300. In the exemplary embodiment, the delivery module 210 further maintains the delivered amount by adding, editing, deleting, etc.

The workstation module 220 downloads the work-in-process amount of the finished product and the semi-product at each workstation thereof, and transmits the work-in-process amount to the alarm management module 300. In the exemplary embodiment, the workstation module 220 further maintains the work-in-process amount by adding, editing, deleting, and so on.

The hourly production module 230 downloads the hourly production amount of the finished product and the semi-finished product at each workstation thereof. In the exemplary embodiment, the hourly production module 230 further maintains the hourly production amount by adding, editing, deleting, etc.

The storage module 240 downloads the stored amount of the finished product, and transmits the stored amount to the alarm management module 300. In the exemplary embodiment, the storage module 240 further maintains the stored amount by adding, editing, deleting, etc.

The alarm management module 300 receives the planned delivery data from the plan management module 100, and the production data from the production management module 200. The alarm management module 300 determines whether the production data conform to the planned delivery data, and generates an alarm if the production data do not conform to the planned delivery data. In the exemplary embodiment, the alarm management module 300 simultaneously determines whether the finished product and the semi-finished product conform to the planned delivery data. If there is conformance, the alarm management module 300 does not generate an alarm. If there is not conformance, the alarm management module 300 generates an alarm.

In another exemplary embodiment, the alarm management module 300 may first determine whether the finished product conforms to the planned delivery data, and then determine whether the semi-finished product for composing the finished product conforms to the planned delivery data.

The alarm management module 300 includes a computing module 310, a judgment module 320, and an alarm module 330. The computing module 310 computes production statuses of the finished product and the semi-finished product at each workstation thereof according to the planned delivery data and the production data. In the exemplary embodiment, results of the computations of the production statuses indicate whether the production data conform to the planned delivery data. If each result is less than a predetermined value, the production data conform to the planned delivery data. In the exemplary embodiment, the predetermined value is 0. If one or more of the results is not less than the predetermined value, the production data do not conform to the planned delivery data. In the exemplary embodiment, the production status may be equal to a negative result, zero or a positive result. A negative result means production is ahead of schedule, zero means on schedule, and a positive result means production is behind schedule.

The computing module 310 utilizes a formula for calculating a production status of the finished product at the rear-end workstation, and another formula for calculating another production status of the semi-finished product at each workstation in the front-end order list.

The production status of the finished product at the rear-end workstation is calculated according to the following formula: x=(a−b−c−d)/e+f−g

In the above formula, x is defined as the production status of the finished product at the rear-end workstation, a is defined as the planned delivery amount of the finished product, b is defined as the stored amount of the finished product, c is defined as the delivered amount of the finished product, d is defined as the work-in-process amount of the finished product at the rear-end workstation, e is defined as the hourly production amount of the finished product at the rear-end workstation, f is defined as a predetermined delay time in hours, and g is defined as a time in hours remaining until final scheduled delivery. Accordingly, (a−b−c−d) is defined as a deficient amount of the finished product at the rear-end workstation in order to conform to the planned delivery schedule. The predetermined delay time is to provide a time buffer in case of unforeseen delays to ensure delivery of the products on time. The inclusion of a predetermined delay time in the formula will ensure an hourly production schedule designed to fill the desired quota ahead of a deadline. In the exemplary embodiment, the predetermined delay time is about 1 to 8 hours. Other units of measure may be used for e, f, and g as well such as days.

Accordingly, the production status of the semi-finished product at each workstation in the front-end order list is calculated according to the following formula: y=((a−b−c−d)−h)/i+f−g

In the above formula, y is defined as the production status of the semi-finished product at each workstation in the front-end order list, (a−b−c−d) is defined as the deficient amount of the finished product at the rear-end workstation, h is defined as the sum of the work-in-process amounts of the semi-finished product at each workstation behind the current workstation in the front-end order list. For example, if there are five workstations in the front-end order list and the formula is being applied to workstation 1, then h equals the sum of the WIP's of workstations 2-5. If the formula is being applied to workstation 3, then h equals the sum of the WIP's of workstations 4 and 5. i is the hourly production amount of the semi-finished product at the current workstation, f is defined as the predetermined delay time in hours, and g is defined as the time remaining in hours until final scheduled delivery. The predetermined delay time is designed to increase the hourly production amount in order to deliver the products on time.

The judgment module 320 determines whether each production status computed by the computing module 310 is less than a predetermined value. The predetermined value is set by manufacturers. In the exemplary embodiment, the predetermined value is 0. If each result is less than the predetermined value, the alarm module 330 does not generate an alarm. If one or more of the results is not less than the predetermined value, the alarm module 330 generates the alarm.

In the exemplary embodiment, the alarm generated by the alarm module 330 includes data such as an alarm content, an alarm workstation, an alarm grade, and an alarm list. The alarm content contains data of the finished product or the semi-finished product not conforming to the planned delivery schedule. The alarm workstation represents the workstations not conforming to the planned delivery schedule. The alarm grade represents a grade representing severity of non-conformance to the planned delivery schedule. In the exemplary embodiment, a computed production status result less than 10 is defined as a first grade, a result between 10 and 20 is defined as a second grade, and a result greater than 20 is defined as a third grade. In other embodiments, the grades can be assigned according to different requirements. The alarm list includes data of related workers responsible for the products not conforming to the planned delivery schedule. In the exemplary embodiment, the related workers include workers responsible for engineering, workers responsible for quality, and workers responsible for manufacturing. The alarm module 330 further sends e-mails to the related workers according to the alarm list.

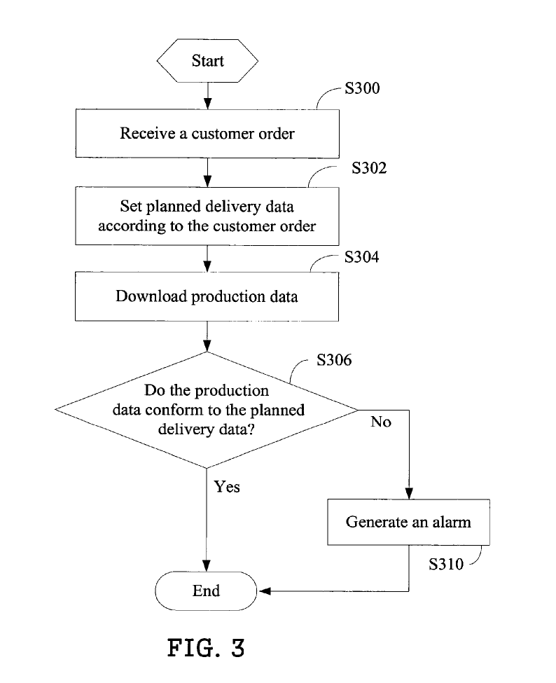

FIG. 3 is a flowchart of a method for production schedule control of an exemplary embodiment of the present invention. In the exemplary embodiment, the alarm system 10 generates an alarm when actual production does not conform to a planned production schedule.

In step S300, the plan management module 100 receives a customer order. In step S302, the plan management module 100 sets planned delivery data according to the customer order, and transmits the planned delivery data to the alarm management module 300. In step S304, the production management module 200 downloads production data from the data server 400, and transmits the production data to the alarm management module 300. In step S306, the alarm management module 300 receives the planned delivery data and the production data, and determines whether the production data conform to the planned delivery data. If the production data do not conform, in step S310, the alarm management module 300 generates an alarm.

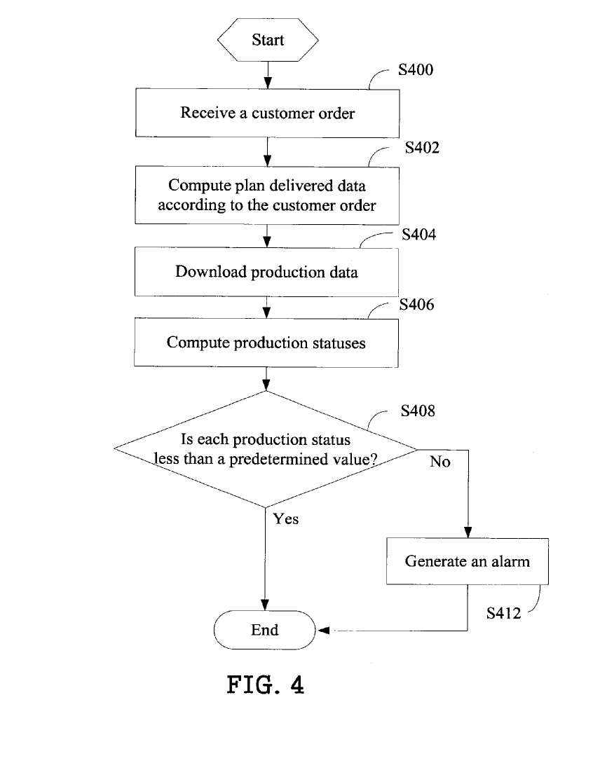

FIG. 4 is a flowchart of a method for production schedule control of another exemplary embodiment of the present invention. In the exemplary embodiment, the alarm system 10 generates an alarm when actual production does not conform to a planned production schedule.

In step S400, the order management module 110 of the plan management module 100 receives a customer order, and transmits the customer order to the planned delivery module 120. In the exemplary embodiment, the customer order includes a finished product composed of a semi-finished product. The finished product is manufactured by a rear-end workstation, and the semi-finished product is manufactured by a plurality of workstations in a front-end order list. In step S402, the planned delivery module 120 receives the customer order, sets planned delivery data according to the customer order, and transmits the planned delivery data to the computing module 310 of the alarm management module 300. In the exemplary embodiment, the planned delivery data include a planned delivery amount of the finished product.

In step S404, the production management module 200 downloads production data from the data server 400, and transmits the production data to the computing module 310. In the exemplary embodiment, the production data includes an hourly production amount of the finished product and the semi-finished product at each workstation thereof, a work-in-process (WIP) amount of the finished product and the semi-finished product at each workstation thereof, a delivered amount of the finished product, and a stored amount of the finished product. The delivery module 210 downloads the delivered amount from the data server 400. The workstation module 220 downloads the work-in-process amount from the data server 400. The hourly production module 230 downloads the hourly production amount from the data server 400. The storage module 240 downloads the stored amount from the data server 400.

In step S406, the computing module 310 computes production statuses of the finished product and the semi-finished product at each workstation thereof according to the planned delivery data and the production data. In the exemplary embodiment, the computing module 310 receives the planned delivery data from the plan management module 100, and the production data from the production management module 200, and then computes the production statuses. The computing method of each production status has been described above, so further description is omitted herefrom.

In step S408, the judgment module 320 determines whether each computed production status result is less than a predetermined value.

If one or more of the results is not less than the predetermined value, in step S412, the alarm module 330 generates an alarm. In the exemplary embodiment, the alarm data generated by the alarm module 330 includes products, workstations and grades with the computed results that are not less than the predetermined value, and the alarm module 330 sends e-mails to related workers.

By employing the method for production schedule control of the present invention, when actual production does not conform to a planned production schedule, the alarm system 10 can generate an alarm to inform related workers to check and adjust production schedules to ensure delivery of the products to customers on time.

While various embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. An alarm system for production schedule control, comprising:
a plan management module, for receiving a customer order and setting planned delivery data according to the customer order;
a production management module, for downloading production data; and
an alarm management module, for determining whether the production data conform to the planned delivery data and generating an alarm if the production data do not conform to the planned delivery data.

2. The alarm system as claimed in claim 1, further comprising a data server for storing the production data.

3. The alarm system as claimed in claim 1, wherein the plan management module comprises an order management module for receiving the customer order and a planned delivery module for setting the planned delivery data according to the customer order.

4. The alarm system as claimed in claim 3, wherein the plan management module further comprises a data maintaining module for maintaining the planned delivery data.

5. The alarm system as claimed in claim 4, wherein the data maintaining module comprises searching, editing, and deleting functions.

6. The alarm system as claimed in claim 1, wherein the production data comprise an hourly production amount of each finished product and each semi-finished product at each workstation thereof, a work-in-process amount of each finished product and each semi-finished product at each workstation thereof, a delivered amount of each finished product, and a stored amount of each finished product.

7. The alarm system as claimed in claim 6, wherein the production management module comprises a delivery module for downloading the delivered amount of the finished product, a workstation module for downloading the work-in-process amount of the finished product and the semi-finished product at each workstation thereof, an hourly production module for downloading the hourly production amount of the finished product and the semi-finished product at each workstation thereof, and a storage module for downloading the stored amount of the finished product.

8. The alarm system as claimed in claim 6, wherein the alarm management module comprises a computing module for computing production statuses of the finished product and the semi-finished product at each workstation thereof according to the planned delivery data and the production data.

9. The alarm system as claimed in claim 8, wherein the planned delivery data include a planned delivery amount of the finished product, the finished product is manufactured by a rear-end workstation, and the semi-finished product is manufactured by a plurality of workstations in a front-end order list.

10. The alarm system as claimed in claim 9, wherein the computing module utilizes the following formula for calculating a production status of the finished product at the rear-end workstation:
the production status=(the planned delivery amount of the finished product−the stored amount of the finished product−the delivered amount of the finished product−the work-in-process amount of the finished product at the rear-end workstation)/(the hourly production amount of the finished product at the rear-end workstation)+(a predetermined delay time in hours)−(a time in hours remaining until final scheduled delivery), wherein the inclusion of the predetermined delay time facilitates obtaining of an hourly production schedule to fill a desired quota ahead of a deadline.

11. The alarm system as claimed in claim 9, wherein the computing module utilizes the following formula for calculating a production status of the semi-finished product at each workstation in the front-end order list:
the production status=(the planned delivery amount of the finished product−the stored amount of the finished product−the delivered amount of the finished product−the work-in-process amount of the finished product at the rear workstation−the sum of the work-in-process amounts of the semi-finished product at each workstation behind the current workstation in the front-end order list)/(the hourly production amount of the semi-finished product at the current workstation)+(a predetermined delay time in hours)−(a time remaining in hours until final scheduled delivery), wherein the predetermined delay time facilitates increasing the hourly production amount in order to deliver the finished product on time.

12. The alarm system as claimed in claim 8, wherein the alarm management module further comprises a judgment module for determining whether each computed production status result is less than a predetermined value.

13. The alarm system as claimed in claim 12, wherein the alarm management module further comprises an alarm module for generating an alarm according to the computed result from each computation of production status.

14. A method for production schedule control, comprising the steps of:
receiving a customer order;
setting planned delivery data according to the customer order;
downloading production data;
determining whether the production data conform to the planned delivery data; and
generating an alarm if the production data do not conform to the planned delivery data.

15. The method as claimed in claim 14, wherein the production data comprise an hourly production amount of each finished product and each semi-finished product at each workstation thereof, a work-in-process amount of each finished product and each semi-finished product at each workstation thereof, a delivered amount of each finished product, and a stored amount of each finished product.

16. The method as claimed in claim 15, wherein the downloading step comprises the steps of:
downloading the delivered amount of the finished product;
downloading the work-in-process amount of the finished product and the semi-finished product at each workstation thereof;
downloading the hourly production amount of the finished product and the semi-finished product at each workstation thereof; and
downloading the stored amount of the finished product.

17. The method as claimed in claim 15, wherein the determining step comprises the steps of:
computing production statuses of the finished product and the semi-finished product at each workstation thereof according to the planned delivery data and the production data; and
determining whether each computed production status result is less than a predetermined value.

18. The method as claimed in claim 17, wherein the planned delivery data include a planned delivery amount of the finished product, the finished product is manufactured by a rear-end workstation, and the semi-finished product is manufactured by a plurality of workstations in a front-end order list.

19. The method as claimed in claim 18, wherein the computing step comprises:
computing a production status of the finished product at the rear-end workstation according to the following formula:
the production status=(the planned delivery amount of the finished product−the stored amount of the finished product−the delivered amount of the finished product−the work-in-process amount of the finished product at the rear-end workstation)/(the hourly production amount of the finished product at the rear-end workstation)+(a predetermined delay time in hours)−(a time in hours remaining until final delivery), wherein the inclusion of the predetermined delay time facilitates obtaining of an hourly production schedule to fill a desired quota ahead of a deadline.

20. The method as claimed in claim 18, wherein the computing step comprises:
computing a production status of the semi-finished product at each workstation in the front-end order list according to the following formula:
the production status=(the planned delivery amount of the finished product−the stored amount of the finished product−the delivered amount of the finished product−the work-in-process amount of the finished product at the rear-end workstation−the sum of the work-in-process amounts of the semi-finished product at each workstation behind the current workstation in the front-end order list)/(the hourly production amount of the semi-finished product at the current workstation)+(a predetermined delay time in hours)−(a time in hours until final scheduled delivery), wherein the predetermined time facilitates increasing the hourly production amount in order to deliver the finished product on time.
